(19) United States
(12) Patent Application Publication
(10) Pub. No.: US 2009/0034245 A1
(43) Pub. Date: Feb. 5, 2009

(54) Movement-responsive, illuminated, household accessories

(76) Inventor: Ezra Esses, Brooklyn, NY (US)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 11/888,048

(22) Filed: Jul. 31, 2007

(51) Int. Cl. F21V 31/00; F21L 4/00

(52) U.S. Cl. 362/158

(57) ABSTRACT

A household accessory, such as bed linens, bath linens, kitchen linens, furniture linens, and table linens, is illuminated with flashing lights in response to movement and is protected against water damage.

### BACKGROUND OF THE INVENTION

1. Field of the Invention

The present invention generally relates to accessories and, more particularly, to household accessories, such as bed accessories, bath accessories, kitchen accessories, furniture accessories, and table accessories, each accessory being illuminated in response to movement.

2. Description of the Related Art

Household accessories, such as bed accessories, bath accessories, kitchen accessories, furniture accessories, and table accessories, are, of course, used by men, women and children. As advantageous as the known accessories have been, improvements can still be made in their use, particularly for providing a more visually stimulating appearance.

### SUMMARY OF THE INVENTION

### Object of the Invention

Accordingly, it is a general object of this invention to provide a visually stimulating, eye-catching display on a household accessory.

### Features of the Invention

In keeping with the above object and others which will become apparent hereinafter, one feature of the present invention resides, briefly stated, in a movement-responsive, illuminated household accessory, preferably constituted of any natural or synthetic material, such as cotton, wool, nylon, silk, linen, or like cloth material. The household accessory includes a lighting module supported thereon, and operative for emitting light in response to movement of the module, for example, by the user. The module includes a battery, at least one light source and preferably a plurality of light sources, and a movement-responsive switch for connecting the battery to the light sources to cause the latter to emit light. Preferably, a processor is connected between the light sources and the switch in order to cause the light sources to emit the light in accordance with a flash pattern determined by the processor.

Means are provided for resisting entry of water to the module. The water may come from a variety of sources, for example, as moisture evaporating from the user's body in the case of bed or furniture accessories, as bathing water in the case of bath accessories, as liquid from food or drink in the case of table, kitchen or furniture accessories, or as wash water used during laundering of any of the accessories. Such water can cause failure of the lights to emit light. To resist such failure, the resisting means includes a heat-fused seal extending around a periphery of the module and sealing the module to the accessory and/or a sealed envelope in which the module is sealingly contained and/or a synthetic plastic material for encapsulating the module.

The encapsulated module preferably has opposite, flattened surfaces. Even the light sources, which are preferably light emitting diodes, have electrodes that are flush-mounted with the flattened surfaces of the module, and thus do not provide any raised points which might serve as a source of discomfort when placed adjacent a user's body. The encapsulated module is a generally planar disk with rounded corners which do not cause user discomfort.

A support is attached, for example, by stitching, by adhesion, or by heat-sealing, to the accessory. The support bounds a compartment in which the module is received and held. The support may be a single, flexible sheet juxtaposed with the accessory to bound the compartment therewith. The support may overlie an exterior surface of the accessory, or may underlie an interior surface of the accessory. The support may also be a pair of juxtaposed sheets that bound the compartment between the sheets. The pair of juxtaposed sheets are interconnected, preferably by a heat seal around their peripheries, and the interconnected sheets are attached to the accessory, either to the exterior or interior surface of the accessory, with the module already in the compartment. In one embodiment, at least one of the sheets is transmissive to the light emitted by the light sources. Preferably, a decoration, graphic or design is provided on the support, and the decoration is illuminated by the emitted light. In another embodiment, at least one of the sheets is apertured to enable the light emitted by the light sources to pass through the apertures in the sheet.

In accordance with this invention, the flashing lights create an eye-catching display whether the accessory is used by day or by night. In addition, the module is preferably mounted at a corner of the accessory, again to avoid user discomfort during its use.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a front elevational view of an accessory in accordance with this invention;

FIG. 2 is an enlarged sectional view taken on line 2-2 of FIG. 1;

FIG. 3 is a perspective view of an encapsulated lighting module for use with this invention;

FIG. 4 is an exploded view of the lighting module prior to assembly and encapsulation; and

FIG. 5 is an electrical schematic of a circuit used in the lighting module of FIG. 3.

### DETAILED DESCRIPTION OF THE PREFERRED EMBODIMENTS

Referring now to the drawings, reference numeral 10 generally identifies a representative household accessory, such as bed accessories, bath accessories, kitchen accessories, furniture accessories, and table accessories. By way of example, bed accessories or bed linens may include a sheet, a blanket, a quilt, a pillowcase, a comforter, a bedspread, a mattress cover, a dust ruffle, a duvet, a pillow sham, etc. Bath accessories or bath linens may include a towel, a washcloth, a shower curtain, a toilet seat cover, a toilet tank cover, a bath mat, a bath rug, etc. Kitchen accessories or kitchen linens may include a placemat, a towel, a napkin, etc. Furniture accessories or furniture linens may include a throw pillow, a slip cover, etc. Table accessories or table linens may include a tablecloth, a placemat, a table runner, etc. Each accessory is preferably constituted, in whole or in part, of any natural or synthetic material, such as cotton, wool, nylon, silk, linen, or like cloth material.

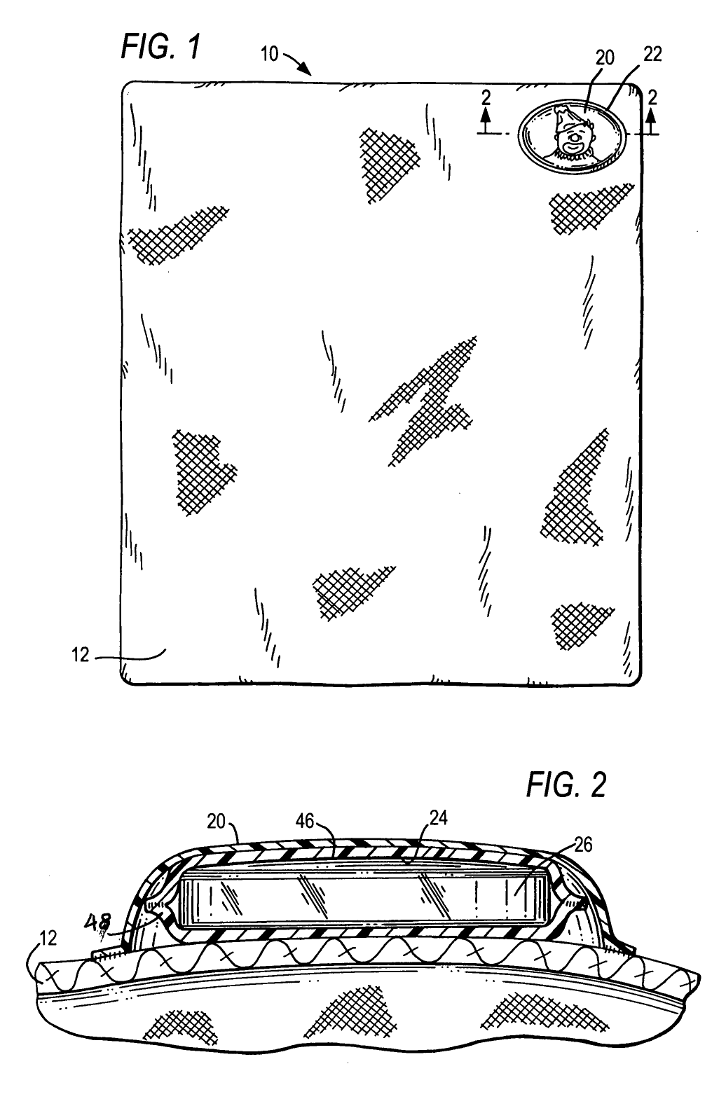

A support such as an overlay 20 is attached, for example, by stitching, by adhesion, or by heat-sealing, to an outer, exterior surface of the representative accessory 10, for example, a blanket 12, preferably in a corner thereof, as shown in FIG. 1. As shown, the overlay 20 is fused to the accessory along a heat-fused seal 22 that extends preferably around the entire periphery of the overlay, although the seal may also extend partially around the periphery to form an open pocket. The overlay is preferably a single sheet constituted of a soft, flexible, light-transmissive material, such as rubber or plastic, and bears a decoration, for example, by being molded with a graphic, such as the illustrated three-dimensional clown face, thereon. The overlay forms a compartment 24, as best seen in the sectional view of FIG. 2, with the accessory. The single sheet support could also be attached, for example, by stitching, by adhesion, or by heat-sealing, to an inner, interior surface of the accessory.

Rather than a single sheet, the support could be comprised of a pair of juxtaposed sheets that bound the compartment between the sheets. The pair of juxtaposed sheets are preferably interconnected, for example, by a heat seal around their peripheries, and the interconnected sheets are attached, for example by stitching, adhesion, or a heat-fused seal, to the exterior or interior surface of the accessory. At least one of the interconnected sheets is preferably constituted of a soft, flexible, light-transmissive material.

A lighting module 26 is received and held in the compartment 24. As best seen in the exploded view of FIG. 4, the module 26 includes a battery 28, typically a flat circular disk battery commonly used in cameras, a battery holder 30 having a resilient finger 32 for engaging one side of the battery, a planar support such as a printed circuit board 34, a processor 36 mounted on the board 34, at least one light source and preferably a plurality of light sources 38A, B, C, D also mounted on the board 34, and a movement-responsive switch 40 electrically connected to the processor 36, the battery 28, and the light sources 38A, B, C, D in the manner illustrated in the circuit of FIG. 5.

The switch 40 includes an electrically conductive outer sleeve 42 in which an electrically conductive coil spring 44 is mounted for movement between an open position in which the spring is located out of physical conductive contact with the sleeve 42, and a closed position in which the spring contacts the sleeve 42. Movement of the spring is caused by movement of the module and the accessories, for example, by a user and, to aid such spring movement, the free end of the cantilevered spring 44 can be weighted. The movement-responsive switch can also be a roller ball rollable between electrical contacts between the open and closed positions.

In the closed position of the switch 40, the processor is energized by the battery and causes the light sources to emit light, preferably flashes of light in a pattern determined by the processor. The pattern may be predetermined or random. The flashing can occur immediately when the closed position is reached, or after a time delay. The flashing is terminated after a predetermined time, or after a randomly chosen time interval. Continuous illumination is contemplated, but not preferred to minimize power consumption. The processor could be eliminated, in which case, the light sources will emit their light whenever the switch closes.

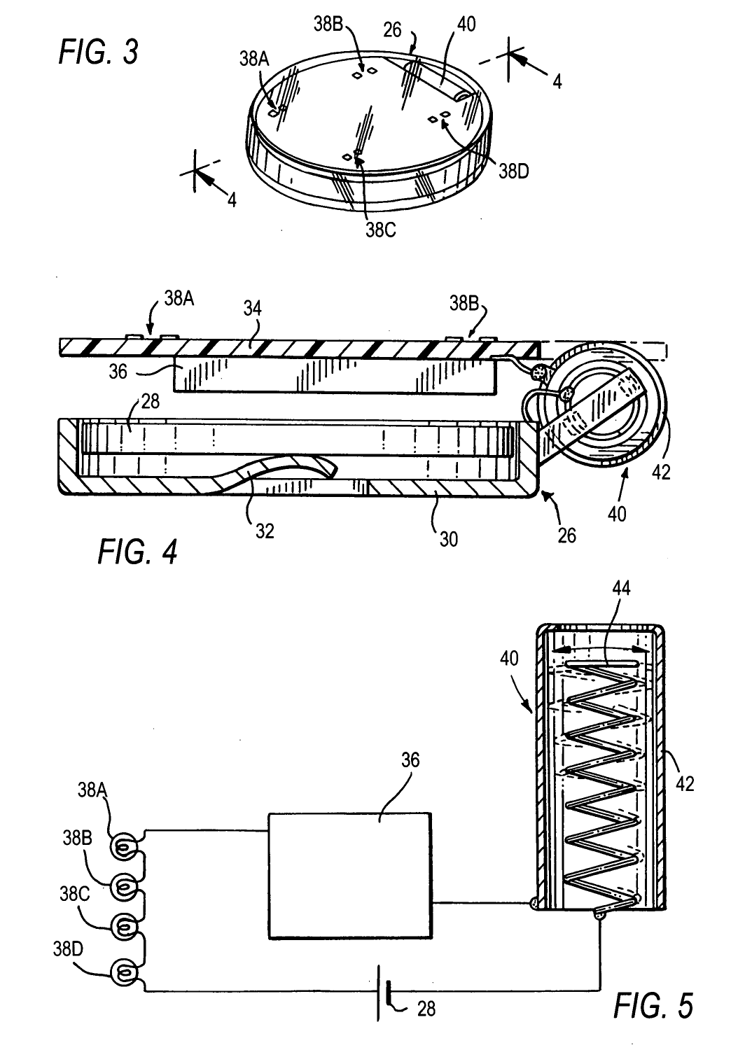

The light sources are preferably light emitting diodes operative for emitting light of the same or different colors. Each diode includes a pair of planar electrodes, as best seen in FIG. 3, which are flush-mounted on an exterior planar surface of the board 34.

As best seen in FIG. 3, the module 26 is encapsulated in a synthetic plastic material which is preferably light-transmissive. The encapsulated module has smooth, flattened major surfaces and has a circular or ovoidal disk shape. All of the components of the module are potted inside the encapsulated plastic, and there are no exposed rough edges. The encapsulating plastic was not shown in FIG. 4 so as not to encumber this drawing.

Water is prevented from entering and damaging the module by the aforementioned seal 22, and/or by the aforementioned encapsulating plastic, and/or by an envelope comprised of juxtaposed plastic sheets 46, 48 (see FIG. 2) which are sealed about their periphery and which sandwich the module therebetween. Plural envelopes can also be used.

In use, the module is mounted on an exterior or interior surface of the accessory. Even if a force presses the module against the user, there is no discomfort, because the module has no exposed rough edges. As the module is moved, the light emitted by the module passes through the light-transmissive encapsulating plastic, the light-transmissive envelope, and the light transmissive support and illuminates the decoration thereon. In another variation, the light emitted by the module passes through one or more holes either formed in an overlying support, or formed in the accessory itself.

It will be understood that each of the elements described above, or two or more together, also may find a useful application in other types of constructions differing from the types described above. For example, the decoration need not be a molded graphic as illustrated, but can be any design, including embroidery.

While the invention has been illustrated and described as embodied in a movement-responsive, illuminated household accessories, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1-20. (canceled)

21: A motion-responsive illuminated household accessory, comprising:
a lighting module bounded by a synthetic plastic, light-transmissive material, for resisting entry of water into the module, and for transmitting light through the light-transmissive material in response to motion, the module containing at least one energizable light source for emitting the light when energized, a battery for supplying electrical power, and a motion-responsive switch for connecting the battery to the light source to energize the latter to emit the light for transmission through the light-transmissive material of the module; and
a flexible overlay laying entirely over the module containing the light source, the battery and the motion-responsive switch, the overlay having a periphery entirely connected to the household accessory for permanently holding the module on the household accessory, the overlay being transmissive to the light transmitted through the light-transmissive material of the module.

22: The household accessory of claim 21, wherein the household accessory is made of a material selected from natural and synthetic materials.

23: The household accessory of claim 21, wherein the household accessory is selected from bed linens, bath linens, kitchen linens, furniture linens and table linens.

24: The household accessory of claim 21, wherein the lighting module includes a processor in the module for flashing the light source when the battery is connected to the light source by the motion-responsive switch.

25: The household accessory of claim 24, wherein additional light sources are operatively connected to the processor for flashing all the light sources in a pattern.

26: The household accessory of claim 21, wherein the motion-responsive switch includes a coil spring mounted within a sleeve for movement between an open position in which the spring is spaced from the sleeve, and a closed position in which the spring contacts the sleeve.

27: The household accessory of claim 21, wherein the lighting module includes a planar support, and wherein the light source is a light emitting diode (LED) having planar electrodes mounted flush with the planar support.

28: The household accessory of claim 21, and a sealed, flexible envelope in which the module containing the light source, the battery, and the motion-responsive switch is sealingly contained and sandwiched between juxtaposed plastic sheets, for resisting the entry of the water into the envelope and the module, the juxtaposed plastic sheets being of a light-transmissive material that is transmissive to the light transmitted through the light-transmissive material of the module, and wherein the overlay lays entirely over the envelope containing the module.

29: The household accessory of claim 21, wherein the module has rounded corners.

30: The household accessory of claim 21, and a design on the overlay, the design being illuminated by the light transmitted through the light-transmissive material of the module.

31: The household accessory of claim 21, and a heat-fused seal extending around the module and around the periphery of the overlay and sealing the overlay over the module to the household accessory, for resisting the entry of the water into the module containing the battery, the light source, and the motion-responsive switch.

32: The household accessory of claim 21, wherein the light source, the battery and the motion-responsive switch are encapsulated by the synthetic plastic, light-transmissive material of the module.

33: The household accessory of claim 21, wherein the module is attached to a corner of the household accessory.

34: A motion-responsive illuminated household accessory, comprising:
a lighting module bounded by a synthetic plastic, light-transmissive material, for resisting entry of water into the module, and for transmitting light through the light-transmissive material in response to motion, the module containing a plurality of energizable light emitting diodes (LEDs) for emitting the light when energized, a battery for supplying electrical power, and a motion-responsive switch for connecting the battery to the LEDs to energize the latter to emit the light for transmission through the light-transmissive material of the module;
a sealed, flexible envelope in which the module containing the LEDs, the battery, and the motion-responsive switch is sealingly contained and sandwiched between juxtaposed plastic sheets, for resisting the entry of the water into the envelope and the module, the juxtaposed plastic sheets being of a light-transmissive material that is transmissive to the light transmitted through the light-transmissive material of the module; and
a flexible overlay laying entirely over the envelope and the module containing the LEDs, the battery and the motion-responsive switch, the overlay having a periphery entirely connected to the household accessory for permanently holding the envelope and the module on the household accessory, the overlay being transmissive to the light transmitted through the light-transmissive material of the envelope and of the module, the overlay having a design illuminated by the light transmitted through the light-transmissive material of the envelope and of the module.

35: The household accessory of claim 34, and a heat-fused seal extending around the envelope and the module and around the periphery of the overlay and sealing the overlay over the envelope and the module to the household accessory, for resisting the entry of the water into the envelope and the module containing the battery, the LEDs, and the motion-responsive switch.

36: The household accessory of claim 34, wherein the lighting module includes a processor for flashing the LEDs in a pattern when the battery is connected to the LEDs by the motion-responsive switch.
